(19) United States
(12) Patent Application Publication
(10) Pub. No.: US 2010/0193126 A1
(43) Pub. Date: Aug. 5, 2010

(54) METHOD OF CEMENTING ALUMINIUM OBJECTS

(76) Inventors: Arild Saasen, Stavanger (NO); Hallvar Eide, Stavanger (NO); Rune Godøy, Stavanger (NO)

Correspondence Address: Ballard Spahr LLP, SUITE 1000, 999 PEACHTREE STREET, ATLANTA, GA, 30309-3915, US

(21) Appl. No.: 12/451,803

(22) PCT Filed: Jun. 2, 2008
(86) PCT No.: PCT/GB2008/001860

§ 371 Date: Mar. 31, 2010

(30) Foreign Application Priority Data
Jun. 1, 2007 (GB) 0710520.8

(51) Int. Cl. C04B 28/08

(52) U.S. Cl. 156/325

(57) ABSTRACT

This invention provides a method of securing to a substrate a metal object having an uncoated surface, which method comprises contacting said substrate and said surface with an unset hydraulic cement composition and allowing said composition to set, characterized in that said surface is an aluminum surface and in that said composition comprises pulverulent aplite.

This invention relates to a method of cementing in place aluminum objects, eg poles, ducts, pegs, tubes, wires, etc.

Not least because of its weight, cost, strength, lack of ferri/ferro-magnetic properties and corrosion resistance, aluminum is the material of choice for many construction purposes.

Hydraulic cement is a mixture of inorganic compounds which set and develop strength as a result of hydration. The best known such cement is Portland cement which is a combination of tricalcium silicate, dicalcium silicate, tricalcium aluminate, tetracalcium aluminoferrite, and gypsum. The setting process involves an exothermic reaction in which aluminum participates and which normally is terminated by the inclusion in the cement composition of gypsum. However, when an aluminum object is in contact with the unset cement, the gypsum in the cement is insufficient to terminate the exothermic reaction and the cement overheats.

Heat of course causes the aluminum object to expand and once cement setting is complete and the aluminum object cools and shrinks an unacceptable gap is left between the object and the cement. To this shrinkage of the aluminum object is of course added the normal shrinkage of the cement on setting, generally about 3-4% by volume. This problem cannot be addressed by raising the gypsum content of the cement to a level sufficient to terminate the exothermic aluminum reaction since the resulting cement tends to expand thereby risking distorting or fracturing the aluminum object and the substrate to which it is being cemented. (High gypsum cement with an enormous capacity to expand is known as “Trollkraft” and is used for rock fragmentation.

As a result, aluminum objects cannot simply be secured in place using hydraulic cements.

One solution to securing aluminum objects is of course to use organic resin cements; these however are much more expensive, can release undesired volatile organic compounds into the environment, and are much more problematic than hydraulic cements to mix, pour and clean up when used on a large scale.

Another solution is to coat the aluminum object with a polymer, eg an acrylic or polyester paint, thereby preventing contact between the metal surface and the unset cement composition. This however adds to the cost and complexity of production of the aluminum object and also means that care must be taken to avoid surface abrasion of the coated aluminum object, thereby also raising the cost and complexity of storage, transport and installation of the aluminum object. For small, relatively inexpensive, objects such as bolts, pins, screws, hooks, etc., it is normally the case that these are packaged, stored and transported in bulk rather than as individual items. The normal conditions experienced during such phases means that the risk of any plastics surface coating being breached, eg due to the objects rubbing against each other, is high and thus plastics coating does not adequately avoid the possibility of reaction between exposed aluminum surfaces and hydraulic cement on eventual end use. For larger, heavier objects, eg tubes, cylinders, beams, girders, etc., even if individual packaging is feasible, handling at the end use site may involve significant risk of breaching of any plastics coating.

However, we have now surprisingly found that hydraulic cements containing aplite may satisfactorily be used for cementing of uncoated aluminum objects.

Thus viewed from one aspect the invention provides a method of securing to a substrate a metal object having an uncoated surface, which method comprises contacting said substrate and said surface with an unset hydraulic cement composition and allowing said composition to set, characterized in that said surface is an aluminum surface and in that said composition comprises pulverulent aplite.

The cement composition used in the method of the invention may contain aggregate, ie particles of rock or the like of millimeter to centimeter dimension, in which case on setting it will form a concrete.

The cement composition may be left alone to set, or if desired setting may be accelerated by intervention, eg by heating or addition of a setting accelerator.

The uncoated aluminum surface which is to be secured will of course generally have an oxide layer as is normal for aluminum that has been exposed to the atmosphere. If desired, the surface may be anodized.

The metal object to be secured may be entirely of aluminum or alternatively it may comprise at least one part which is of aluminum and at least one other part which is of another material, eg a metal or a non-metal such as wood or plastics for example. The object may thus typically be a construction element, eg a peg, tube, rod, bar, post, screw, bolt, pin, wire, channel, sheet, strip, mesh, grid, girder, cylinder, panel, etc. It is especially effective to use the method of the invention when the object is hollow or cup-shaped in cross section. The wall thickness of the object will typically be in the range 1 to 100 mm, especially 2 to 25 mm.

The method of the invention is particularly suited to the securing in place of aluminum posts (eg fence posts), of aluminum pegs or bolts in brick or rock faces (eg in tunnel walls), of aluminum channels (eg for containing cables or pipes), and of aluminum lining tubes in bore holes.

By “aluminum” when used in relation to material from which a metal object or a part thereof is constructed is meant herein aluminum and alloys and laminates thereof containing at least 30% wt aluminium, preferably at least 90% wt aluminium, more preferably at least 95% wt aluminium.

The substrate referred to above is the object or material to which or inrelation to which the aluminum surface is to be secured, eg rock, glass, bone, brick, ceramic, earth, sand, wood, etc. The cement need not bond to the substrate, or even to the aluminum surface, as long as the shape and size of the set cement mass serves to keep the metal object in place.

Aplite is a granitoid mineral found for example in Montpelier, Va., USA, Owens Valley, Calif., USA and in Finnvolldalen in Norway as well as in Japan, Russia and Tuscany, Italy. Aplite is currently used almost exclusively as a flux in single-fired ceramic tile production. Aplite may be obtained commercially, e.g. from Maffei Natural Resources, Italy and the US Silica Company, West Virginia, USA. Typically aplite contains silicon, magnesium, iron, sodium, aluminum, potassium, titanium and calcium with the major components (expressed as oxide content) being silicon and aluminum, these generally being present at 60-85% wt. and 10 to 25% wt. respectively.

The aplite used according to the present invention is preferably a high silicon content aplite, e.g. with a silicon content (expressed as oxide content) of at least 68% wt., more preferably at least 70% wt., especially at least 75% wt. The aplite from Finnvolldalen in Norway which has a silicon content (expressed as oxide content) of about 80% wt. is especially preferred.

The silicon content is expressed as an oxide content as it is standard geological practice to express elemental contents in this fashion. Thus for example the US Silica Company provides a typical chemical analysis for its aplite (from Montpelier) of SiO₂ 62.0%, Fe₂O, 0.18%, Al₂O₃ 21.7%, TiO₂ 0.30%, CaO 5.6%, MgO 0.034%, Na₂O 5.5%, K₂O 2.9%, P₂O₅ 0.22% and LOI (loss on ignition) 0.1%.

The pulverulent aplite used according to the invention preferably has a particle size of less than 200 μm, more preferably less than 100 μm, e.g. 1 to 100 μm, more typically 10 to 100 μm, e.g. 50 to 100 μm, especially less than 75 μm. Preferably, the aplite used contains fines, ie particles below 15 micrometers, eg below 10 micrometers. This can readily be achieved by grinding the aplite and only screening to remove oversized particles. Particle size in this regard may be measured by screening or using particle size measuring apparatus. Where it is stated that the particle size is less than a certain value, then normally at least 50% volume will be that size or smaller, preferably at least 80% volume. Alternatively particle size may be taken to be mode particle size as measured by a particle size analyser, e.g. a Coulter particle size analyser. Coarse aplite may be transformed into finer grained aplite by conventional rock pulverizing techniques, optionally followed by screening to separate out oversized and/or undersized grains.

On a dry solids basis, the pulverulent aplite additive preferably constitutes at least 10% bwoc (i.e. “by weight of cement”, i.e. by weight relative to the basic composition which is capable of forming a cement), more preferably at least 30% bwoc, especially at least 35% bwoc, more especially at least 50% bwoc, for example up to 400% bwoc and even higher concentrations by weight of cement, more typically up to 200% bwoc, e.g. at least 100% bwoc. Typically the aplite will constitute no more than 85% wt., for example no more than 65% wt., preferably no more than 60% wt., more preferably no more than 55% wt., of the settable cement composition on a dry solids basis.

Compositions containing at least 100% bwoc aplite, e.g. 125 to 200% bwoc, are especially interesting as they are suitable for both low and high temperature usage. Currently different cements have to be used for different depths and temperatures.

The basic cement composition, i.e. the cement base in the compositions used according to the invention, may be any cement capable of use in the conditions in which the metal object is to be secured, for example Portland cement or other conventional cements. Such cement compositions are widely available and have been written about extensively.

Hydraulic cements are usually set by exposing the cement mixture to a base (i.e. to a pH above 7). Exposure to an acid environment, before or after setting, can lead to failure to set properly or to cement corrosion. Thus for example exposure of set Portland cements to carbon dioxide is known to lead to cement corrosion and porosification. The more porous the set cement is, the higher will be the corrosion rate and loss of zonal isolation.

However in some end uses, cements are exposed to acid environments, e.g. to oxide gases such as carbon dioxide, or acidic fluids leaching from the substrate.

Hydraulic cements based on a high aplite content however can be set by the use of acids rather than bases and thus offer the prospect of acid resistant cements. Such acid-setting aplite cements are particularly useful where the substrate and/or the metal object are to be exposed to acidic liquids and gases, eg carbon dioxide or other acidic oxide gases.

These high aplite content cement compositions may contain aplite as the sole cement base or alternatively they may additionally contain at least one further cement base, preferably an inorganic hydraulic cement such as Portland cement. Typically the aplite will constitute at least 82% wt. of the total cement content, preferably at least 84% wt., more preferably at least 85% wt., especially at least 90% wt., e.g. at least 95% wt.

The acid used in setting these high aplite content cements may be any strong or weak acid, e.g. a mineral acid such as hydrochloric acid or an organic acid such as a carboxylic acid, e.g. citric, malic, acetic, etc. acids.

In one preferred embodiment of the invention, the cement is formulated as a solid mix using a solid or encapsulated water-soluble acid, e.g. an acid encapsulated in a soluble polymer, for example a biopolymer such as gelatin. Alternatively an acid may be applied in fluid form, e.g. as a pure liquid acid or an aqueous solution. The acid may even be applied in gaseous form, e.g. by bubbling it through the cement composition.

Generally the acid will be used at a concentration or in an amount such that the pH of the aqueous phase of the cement composition is in the range 2 to 6.9, preferably 3 to 6, more preferably 4 to 5.

In certain instances, a neutral pH may be used to set high aplite-content cements and concretes and such use is also deemed to fall within the scope of the invention.

One particular advantage of the high aplite content elements of the invention is that by selection of the aplite particle size and the aplite content, the temperature reached within the cement during setting may be regulated, e.g. to keep it below 60° C. in temperature sensitive environments or end-uses.

While aplite is a well understood geological term, it should be emphasized herein that other granitoid rocks having the same or similar cement-shrinkage reducing effect, relative to silica, may be used according to the invention in place of materials formally recognised as aplites and that such usage is considered to be according to the invention, although less preferred than the use of materials recognised as aplites.

In addition to aplite, other pulverulent silicates, e.g. silica, in particular silica flour, may also be used in the cement compositions according to the invention; Typically the weight ratio of non-aplite silicate to aplite will be in the range of 0:100 to 90:10, more particularly 2:98 to 70:30, especially 10:90 to 30:70. The use of a non-aplite silicate in addition to aplite is especially preferred when the aplite content is relatively low.

One benefit of the inclusion of aplite is to reduce cement shrinkage on setting. In the absence of aplite, shrinkage may be as high as 4% vol. With 40% bwoc aplite this has been shown to be reduced to 1.2% vol. and at 50% bwoc aplite to 0.7% vol. (tested after 68 hours of curing at 150° C.). The use of such low-shrinkage cements form a preferred embodiment of the invention and in this embodiment the aplite-containing cements of the invention may have a shrinkage on setting of less than 3% by volume. This shrinkage will preferably be less than 2.5%, more preferably less than 2.0% and most preferably less than 2%.

A further considerable advantage of the use of aplite-containing cements according to the present invention is the very low porosity and/or very low permeability of the resulting set cement compositions. Reduced permeability will reduce the invasion of any fluid or gas (e.g. CO₂) and will thus reduce the corrosion of the cement and the transfer of gas or fluid across the cement plug or wall. The water permeability of set Portland cement with slurry density of 1.90 specific gravity (SG) (similar to the aplite free cement composition in Example 3) is around 0.0010 mD (millidarcies), and increases as density is reduced. If reduced to 1.44 SG the water permeability increases to approximately 0.1380 mD. API Spec.10, section 11.4 describes how these permeability tests are performed and will be familiar to one of skill in the art.

The aplite-containing cements used according to the present invention have reduced permeability in comparison with non-aplite containing equivalents. For example, aplite in a Portland cement reduces the permeability over a Portland cement composition of equivalent density. This decreased permeability thereby reduces the invasion of any fluid or gas which will cause cement corrosion and/or loss of zonal isolation. In a preferred embodiment, the aplite-containing cements used according to the present invention thus have a lower permeability once set, according to API Spec.10, section 11.4, than the equivalent set cement prepared in the absence of aplite, and/or the equivalent set cement containing an equivalent quantity of silica flour in place of the aplite component. In this embodiment, the porosity of a cement of density 1.9 SG is typically no more than 0.0005 mD, preferably no more than 0.0003 mD and more preferably no more than 0.0002 mD. Such an absolute or comparative test will easily be carried out according to the known standard.

Aplite (and pulverulent silicate) content in the cement compositions of the invention is defined, as is normal in the industry, as a percentage by dry weight relative to the basic cement composition, e.g. a Portland cement composition, i.e. excluding other additives such as colorants, antimicrobials, organic polymers, fibres, (e.g. inorganic fibres such as glass or “rock wool” fibres), etc. Such other additives, with the exception of additives significantly contributing to the structural (e.g. load-bearing) properties of the set cement, such as silica, will generally contribute no more than 10% wt. dsb (dry solids basis) to the total cement composition, typically less than 5% wt. Besides such additives, the cement composition comprises a cement base, i.e. a material capable of setting to form a cement, more particularly an inorganic cement base. Cement bases, such as Portland cement, are well known in the technological field and require no further description here. Cements are discussed for example in Lea, “The Chemistry of Cement and Concrete”, 3rd Edition, Edward Arnold, Old Woking, UK, 1970, and Taylor, “Cement Chemistry”, Academic Press, London, UK, 1990.

Carbon fibre may be added to the aplite-containing cement to affect several important properties thereof. The most essential of these properties are those related to the set cement, but also in the fluid state, carbon fibres in the cement may increase the ability of the cement to reduce fluid losses to the substrate. Fluid loss is often a problem during cementing operations, and the carbon fibres might in some cases bridge the small fractures causing the losses, and thus lessen these losses.

More important are the properties of the set cement, since the carbon fibres will effect properties such as compressive strength, tensile strength and bond to substrate. Compressive strength is important, but even more important is the increased tensile strength the carbon fibres will give the set cement.

Suitable carbon fibres for use in the invention include those from Devoid AMT AS, N-6030 Langev\dot{a}g, Norway. Preferably the carbon fibres are between 0.1 cm and 10.0 cm in length, more preferably between 0.3 cm and 2.5 cm especially preferably between 0.5 cm and 1.0 cm. Preferred fibres have a diameter of between 1 μm and 15 μm, preferably between 3 μm and 10 μm, more especially between 6 μm and 8 μm, particularly 7 μm. The amount of fibre added per m³ of cement mix (i.e. cement plus aplite, or cement plus aplite plus blast furnace slag) is preferably 0.1 kg to 10 kg, more preferably 0.3 kg to 7 kg, especially preferably 0.5 kg/m³ to 5 kg/m³.

In a particular embodiment of the invention, blast furnace slag (BFS) may be used as all or as part (e.g. from close to 0 (e.g. 2%) to nearly 100% wt (e.g. 90 wt %)) of the cement base. The use of BFS in down-hole cementing applications is discussed for example by Saasen et al in SPE28821, a paper presented at the European Petroleum Conference, London, UK, 25-27 Oct. 1994. BFS is useful in particular as the base for non-self-curing cement compositions, i.e. compositions which can be placed in situ before a further action is taken to initiate setting, e.g. addition of a pH modifier, more specifically an alkaline agent. For some applications, the non-self curing cement composition is applied separately from the curing initiator. For example, the cement composition may be pumped into place before the curing initiator is added or released (e.g. the activator may be placed in the desired location prior to addition of the cement, such as by release from the surface of a metal pipe, etc.), e.g. to bring the pH to above about 9.0. If the cement base is only partly BFS, e.g. with the balance provided by Portland cement, the use of an activator may be unnecessary as the material forming the balance may function as the activator.

Where the cement base is wholly or largely BFS (e.g. greater than 80%, especially greater than 90%, and particularly essentially 100%), the concentration of aplite may be any non-zero concentration but will typically be in the proportions described supra. In particular, the amount of aplite used in this embodiment of the invention may be above 30% by weight of cement base (BFS).

BFS-based cement compositions are currently of particular interest for use in locations where high temperatures may be encountered; however the conventional BFS-based cement compositions still suffer from undesired shrinkage problems that are addressed by the use of aplite according to the invention.

The cement composition used in the present invention is a hydraulic cement, i.e. an inorganic cement rather than a settable organic resin. Such cements are well-known and set and develop strength as a result of hydration. The best known such cement is Portland cement which is a combination of tricalcium silicate, dicalcium silicate, tricalcium aluminate, tetracalcium aluminoferrite, and gypsum. Other components may of course be present, for example the chemical setting retarders or setting accelerators. Examples of retarders (often also referred to as dispersants) include: lignosulphonic acid salts (e.g. the sodium and calcium salts); hydroxycarboxylic acids and their salts, e.g. gluconates and glucoheptonates; citric acid; saccharides and other polyols (e.g. glycerol, sucrose and raffinose); saccharinic acids; cellulosic polymers (e.g. carboxymethylhydroxyethylcellulose); alkylene phosphonic acids and their salts; inorganic acids and their salts (e.g. boric, phosphoric, hydrofluoric and chromic acids and their salts); sodium chloride; and metal oxides (e.g. zinc and lead oxides). For the present invention, saccharide and polyol retarders are preferred. If desired, the cement compositions used according to the invention may contain a delayed release coated setting accelerator so that, after an initial period within which setting is retarded, release of the accelerator, e.g. due to dissolution of a release delaying coating, will then serve to counteract the effects of the chemical retarders. Many inorganic salts, e.g. chlorides (e.g. calcium chloride), carbonates, silicates (for example sodium silicate), aluminates, nitrates, nitrites, sulphates, thiosulphates and hydroxides, serve as accelerators (see for example Nelson et al, “Cement additives and mechanisms of action”, Chapter 3, pages 3-1 to 3-37 in “Well cementing” Ed. Nelson and Guillot, 2nd Edition, Schlumberger, 2006, the contents of which book are hereby incorporated by reference).

The cement compositions used according to the invention may be applied by procedures and equipment conventional in the art for the application of settable cement compositions.

The method of the invention will now be illustrated further with reference to the following non-limiting Examples.

### EXAMPLE 1

Aplite-Containing Cement Composition

A dry cement composition was prepared by mixing 100 parts by weight Class G Portland cement (from Norcem) with 50 parts by weight pulverulent aplite (sieved to a particle size of 75 μm or less) from Finnvolldalen, Norway (content SiO₂ 79.20%; MgO 0.11%; Fe₂O₃ 0.20%; Na₂O 3.0%; Al₂O₃ 11.10%; K₂O 3.90%; TiO₂ 0.02%; CaO 1.29%; P₂O₅ 0.1%).

To this was added 62.01 L/100 kg fresh water.

The mixture was cured in a high pressure/high temperature consistometer at 5000 psi and 150° C. The volumetric shrinkage observed was 0.7%.

Compressive strength, measured in an ultrasonic cement analyser, at 3000 psi and 150° C. (according to the API Recommended Practice for Testing Well Cements, 22nd Edition, 1997) was as set out in Table 1 below:

TABLE 1

| Time | |
|---|---|
| (hours:minutes) | Strength (psi) |
| 1:43 | 50 |
| 2:50 | 500 |
| 24:00 | 3480 |
| 48:00 | 3260 |

### EXAMPLE 2

Aplite-Free Cement Composition (Comparative)

A cement composition was prepared by adding 45.55 L/100 kg fresh water to Class G Portland cement from Norcem. The mixture was cured and tested as in Example 1 showing a volumetric shrinkage of 3.4% and compressive strength as in Table 2 below:

TABLE 2

| Time | |
|---|---|
| (hours:minutes) | Strength (psi) |
| 1:50 | 50 |
| 2:39 | 500 |
| 24:00 | 3296 |

### EXAMPLE 3

Aplite-Containing Cement Composition

A dry cement composition was prepared as in Example 1 but using 40 parts by weight of the aplite. This was mixed with 58.72 L/kg fresh water and cured and tested as in Example 1. The composition showed a volumetric shrinkage of 1.2% and compressive strength as in Table 3 below:

TABLE 3

| Time | |
|---|---|
| (hours:minutes) | Strength (psi) |
| 1:44 | 50 |
| 2:52 | 500 |
| 24:00 | 3227 |
| 48:00 | 2560 |

The cement compositions of Examples 1 and 3 may be formulated and applied down-hole using conventional well-cement application equipment.

### EXAMPLE 4

Crushing and Shrinkage Tests

Cement compositions as set out in Table 4 were prepared and tested using an ultrasonic cement analyser as in Example 1.

TABLE 4

| | Test | Test | Final | Crush | |
|---|---|---|---|---|---|
| | Time | Temperature | Strength | Test | Shrinkage |
| Composition | (hours) | (° C.) | (psi) | (psi) | (%) |
| Norcem G | 24 | 150 | 3294 | — | — |
| Norcem G | 24 | 175 | 1000 | — | 3.4 |
| Norcem G | 68 | 175 | 1000 | — | 3.4 |
| Norcem G | 24 | 20 | 880 | — | — |
| Norcem G + | 24 | 150 | 3962 | — | — |
| 35% Silica | | | | | |
| Norcem G + | 24 | 175 | 3700 | 6939 | 0.5 |
| 35% Silica | | | | | |
| Norcem G + | 68 | 175 | 3300 | 6939 | 0.5 |
| 35% Silica | | | | | |
| Norcem G + | 24 | 150 | 3200 | — | 1.2 |
| 35% Silica | | | | | |
| Norcem G + | 68 | 150 | 2600 | — | 1.2 |
| 35% Silica | | | | | |
| Norcem G + | 24 | 20 | 900 | — | — |
| 35% Silica | | | | | |
| Norcem G + | 68 | 20 | 1772 | — | — |
| 35% Silica | | | | | |
| Norcem G• + | 24 | 150 | 2289 | — | — |
| 10% Aplite | | | | | |
| Norcem G• + | 24 | 150 | 1432 | — | — |
| 15% Aplite | | | | | |
| Norcem G• + | 24 | 150 | 2905 | — | — |
| 40% Aplite | | | | | |
| Norcem G• + | 24 | 175 | 1400 | — | 3 |
| 40% Aplite | | | | | |
| Norcem G• + | 68 | 175 | 1200 | — | 3 |
| 40% Aplite | | | | | |
| Norcem G• + | 24 | 175 | 2200 | 1734 | 3 |
| 50% Aplite | | | | | |
| Norcem G• + | 68 | 175 | 2000 | 1734 | 3 |
| 50% Aplite | | | | | |
| Norcem G + | 24 | 150 | 3200 | — | 1.2 |
| 40% Aplite | | | | | |
| Norcem G + | 68 | 150 | 2600 | — | 1.2 |
| 40% Aplite | | | | | |
| Norcem G + | 24 | 150 | 3450 | — | 0.7 |
| 50% Aplite | | | | | |
| Norcem G + | 68 | 150 | 3200 | — | 0.7 |
| 50% Aplite | | | | | |
| Norcem G + | 24 | 150 | 5000 | 8270 | 1.2 |
| 75% Aplite | | | | | |
| Norcem G + | 68 | 150 | 4316 | 8270 | 1.2 |
| 75% Aplite | | | | | |
| Norcem G + | 24 | 150 | 5800 | — | 0.7 |
| 100% | | | | | |
| Aplite | | | | | |
| Norcem G• + | 68 | 150 | 5438 | — | 0.7 |
| 100% | | | | | |
| Aplite | | | | | |
| Norcem G + | 24 | 150 | 8000 | 8965 | 0.2 |
| 150% | | | | | |
| Aplite | | | | | |
| Norcem G + | 68 | 150 | 7069 | 8965 | 0.2 |
| 150% | | | | | |
| Aplite | | | | | |
| Norcem G + | 24 | 20 | 1600 | — | — |
| 75% Aplite | | | | | |
| Norcem G + | 48 | 20 | 3963 | — | — |
| 75% Aplite | | | | | |
| Norcem G + | 24 | 20 | 4000 | — | — |
| 150% | | | | | |
| Aplite | | | | | |
| Norcem G + | 48 | 20 | 5662 | — | — |
| 150% | | | | | |
| Aplite | | | | | |

* % for silica is bwoc, i.e. relative to the Norcem G
• The aplite used in these tests was inhomogeneous drilling dust. The aplite used in the remaining tests had a particle size of less than 75 μm.

These results show that relatively high quantities of aplite, especially that with a particle size below 75 μm, may be used with advantage, even at low temperatures such as cause problems when using traditional cements in deep water.

### EXAMPLE 5

Carbon Fibre Reinforced Cement

A cement composition may be prepared using Norcem G cement mixed with 150% bwoc aplite (particle size below 75 μm), 0.1-0.3% bwoc (e.g. 0.2% bwoc) carbon fibre and 94 L/100 kg fresh water. The carbon fibre will typically have a fibre length of 5 to 50 mm, e.g. 10 to 40 mm.

### EXAMPLE 6

Aplite-Containing Cement Composition

A dry cement composition is prepared by mixing 23.5 parts by weight Class G Portland cement (from Norcem) with 127.5 parts by weight pulverulent aplite (drilling dusts of particle size 50-150 μm) from Finnvolldalen, Norway (content SiO₂ 79.20%; MgO 0.11%; Fe₂O₃ 0.20%; Na₂O 3.0%; Al₂O₃ 11.10%; K₂O 3.90%; TiO₂ 0.02%; CaO 1.29%; P₂O₅ 0.1%).

To this is added 62.01 L/100 kg fresh water, and optionally hydrochloric acid to bring the aqueous phase pH to below 6.

The mixture is cured under ambient conditions for 2 to 3 hours and then at 40° C. for 8 hours.

### EXAMPLE 7

Aplite-Only Cement Composition

A cement composition was prepared according to Example 6 by adding fresh water to aplite of particle size 10-75 μm (achieved by crushing and sieving). pH was adjusted to 4-5 using hydrochloric acid and the composition was allowed to set for 24 hours at 150° C.

Compressive strength, measured in an ultrasonic cement analyser, at 3000 psi and 150° C. (according to the API Recommended Practice for Testing Well Cements, 22nd Edition, 1997) was as set out in Table 5 below:

TABLE 5

| Time (hours) | Strength (psi) |
|---|---|
| 24 | 10000 |

### EXAMPLE 8

Testing of Cement Compositions

The following cement compositions were tested:
Sample I—pure building cement
Sample II—Class G Portland cement+aplite* (50:50 cement:aplite by volume)
Sample III—Class G Portland cement
Sample IV—building cement+aplite* (50:50 cement:aplite by volume) * The aplite was crushed and then ground in a ball mill (type: Tecon 400 VL). Particles passing through a 75 μm sieve were used.

Each sample was mixed with water (94 lbs cement mix: 41.36 lbs water) and set in a cylindrical plastic flask having an internal diameter of 70 mm. An aluminum pipe (isolated inside with isopore) having an outer diameter of 45 mm was placed in the middle of the flask. The cemented length of the pipe was 110 mm.

Both samples I and III showed cracks (longitudinal creep crack). After 5 days, the force needed to push the aluminum pipes out of the flask was measured using a “Materials Testing Machine” (from ZWICK, type Z020/TH2S). The results are set out in Table 6 below:

TABLE 6

| Sample | Force (kN) |
|---|---|
| I | 1.2 |
| II | 2.9 |
| III | 0.9 |
| IV | 2.6 |

1. A method of securing to a substrate a metal object having an uncoated surface, which method comprises contacting said substrate and said surface with an unset hydraulic cement composition and allowing said composition to set, characterized in that said surface is an aluminum surface and in that said composition comprises pulverulent aplite.

2. A method as claimed in claim 1 wherein said metal object is an object selected from the group consisting of pegs, tubes, rods, bars, posts, screws, bolts, pins, wires, channels, sheets, strips, meshes, grids, girders, cylinders, and panels.

3. A method as claimed in claim 1 wherein aplite constitutes at least 30% bwoc of said cement composition.

4. A method as claimed in claim 1 wherein said cement composition contains carbon fibre.

5. A method as claimed in claim 1 wherein said cement composition contains blast furnace slag.

6. A method as claimed in claim 2 wherein aplite constitutes at least 30% bwoc of said cement composition.

7. A method as claimed in claim 2 wherein said cement composition contains carbon fibre.

8. A method as claimed in claim 3 wherein said cement composition contains carbon fibre.

9. A method as claimed in claim 2 wherein said cement composition contains blast furnace slag.

10. A method as claimed in claim 3 wherein said cement composition contains blast furnace slag.

11. A method as claimed in claim 4 wherein said cement composition contains blast furnace slag.
